(19) United States
(12) Patent Application Publication
(10) Pub. No.: US 2010/0121710 A1
(43) Pub. Date: May 13, 2010

(54) System and method for location-based online shopping and just-in-time advertising

(75) Inventors: Todd L. Chipman, San Jose, CA (US); Mark A. Chipman, Coeur d'Alene, ID (US)

Correspondence Address: Gard and Kaslow LLP, One 1st Street, Suite 9, Los Altos, CA, 94022, US

(73) Assignee: Spreezio, Inc.

(21) Appl. No.: 12/291,696

(22) Filed: Nov. 13, 2008

(51) Int. Cl. G06Q 30/00; G06Q 10/00

(52) U.S. Cl. 705/14.51; 705/14.52; 705/14.58

(57) ABSTRACT

A system for location-based online shopping by which users may make offers to, or solicit offers from, vendors in a particular geographic area, and for almost simultaneously providing advertising to the users is disclosed. Data is received from a user via an electronic communication device, the data designating a product or service of interest to the user and a geographic area in which the user desires to shop. Vendors of the designated product or service in the designated geographic area are selected, and a request related to the designated product or service is sent to the selected vendors. One or more advertisements related to the designated product or service are then sent to the electronic communication device in response to the data received from the device.

### FIELD OF THE INVENTION

The present invention relates generally to online shopping and advertising. More specifically, the present invention allows for shoppers to search and negotiate online for products or services in their geographic areas, and for advertisements related to their search to be shown to the shoppers at the same time when the advertisements are the most relevant to them.

### BACKGROUND OF THE INVENTION

The spread of access to the Internet has dramatically changed shopping for goods. Where most items were previously purchased locally, with some items bought from other geographic areas often by catalog sales and ordered by mail or over the telephone, the Internet allows for virtually instant access to vendors worldwide and for the viewing, selecting and ordering of products very quickly from the shopper's own computer. Thus, shopping with vendors outside the shoppers' geographic area has increased dramatically.

However, one downside of online shopping is that the shopper must generally wait for the product to be shipped, and for transit time. Another issue is that pictures and information available online are not the same as being able to see and try the product itself or, in the case of clothing, to try it on. There are also issues about the confidentiality of information and security of payment online. Thus, many people have turned to using the Internet to research products online, while still choosing to purchase the products locally. According to some studies, while over 90% of shoppers research their prospective purchases online, over 90% of retail sales still take place in a local store.

But purchasing locally after doing online research still has drawbacks as well. Even if the online research yields enough information for a consumer to make a product choice and to determine a target price, it is still often necessary to call or drive to multiple stores to find a store that carries the item, and to determine if it is in stock and perhaps whether it is in the right color and/or size. While some chain stores allow a shopper to check online whether an item is in stock locally, it is still necessary to check each chain or independent store separately. Even checking a chain store may require a shopper to check multiple locations separately rather than showing all locations at which the item is in stock.

Still another issue is that prices change often, as different stores change prices or place different items on sale. While there are many search engines that allow shoppers to check prices at a wide variety of online sellers almost simultaneously, there is no similar mechanism for local sellers. Thus, while determining the best price available online at a given moment in time is relatively easy, determining the best price available locally is much more difficult, again generally requiring some combination of reading advertisements, checking online, or calling or visiting individual stores. Contributing to this price confusion is that some stores will negotiate prices on some items while others will not. Even where stores will negotiate, again at least one or more telephone calls or, more likely, visits are required. Finally, bargaining is often a cultural phenomenon; today many consumers are not comfortable asking for a discount or negotiating the amount of one.

On the other side of a potential transaction, vendors have a corresponding set of problems in trying to advertise to potential shoppers. Traditional print advertising in newspapers, magazines, telephone directories, shopping guides and direct mail appears to be generating diminishing returns and is thus on the decline. Television advertising is becoming less effective; people skip commercials while they watch television online or after recording shows on digital video recorders, or avoid commercial altogether by watching premium channels like HBO, Showtime and the like. More and more music is being downloaded, and some listeners of radio are now listening to commercial free subscription stations or networks such as Sirius XM Radio.

While Internet advertising has increased dramatically in recent years, it is often still directed to large numbers of people and not easily targeted to those few who are actually interested in it. Traditional banner and display advertising to all users has largely come to be seen as annoying, and is thus not very effective; click-throughs have decreased and such ads seem to be on the decline. Advertising tailored to particular searches, such as Google's AdSense, or to particular users who self-identify with certain interests, such as on Facebook, can be very expensive, and there is often no way of telling whether someone who enters a particular search string or claims to have a particular interest is presently considering purchasing something associated with that search or interest.

There may also be significant differences in how stores wish to motivate shoppers to purchase from them. Independent stores often find it difficult to compete with national chain or “big box” stores, particularly on price. They may be unable to get the same economies of scale either in purchasing from the manufacturers, which may include associated sales promotions or incentives, or in advertising costs since a chain may have multiple stores in a given geographic area and thus be able to justify broader and more expensive advertising. They also often find it difficult to carry the same range of products as a larger chain store. Such independent retailers are thus often eager to find a value proposition that will cause consumers to purchase from them rather than from the bigger stores. However, while service may be such a value proposition in some cases, in many instances customers are driven by price alone. Although this may be particularly true for items that do not generally require any setup, for example some consumer electronics, certain kitchen appliances, and others, many smaller vendors can have the opportunity to distinguish themselves and win business through flexible negotiation tactics including offering free delivery or setup, discounted accessories, free consultations or other non-traditional shopper benefits such as product training or deal bundling.

Furthermore, from a salesmans' perspective, a retail sales representative at a large or chain store is often dependent on luck to succeed in selling enough products to meet sales targets or quotas, or to generate commissions at a reasonable level. Such representatives often may have little if any way to distinguish themselves from the numerous other representatives. If a customer looks at a product but then leaves to look for a better price or different product, even if the customer comes back the sales representative in a large store has a much smaller chance of meeting him or her again than one in a small store given the number of representatives at the store, unless the representative has made a sufficient impression (due to superior knowledge, for example) that the customer specifically asks for the representative again.

Present applications do not adequately address these issues of shoppers' access to local information, of sellers' abilities to provide information to local shoppers, and of the effectiveness of advertising.

### SUMMARY OF THE INVENTION

The present invention provides for location-based online shopping by which users may make offers to, or solicit offers from, vendors in a particular geographic area, and for almost simultaneously providing advertising to the users during the shopping process when the advertisements are most likely to have an effect.

In a method according to one embodiment of the present invention, data is received from a user via an electronic communication device, the data designating a product or service of interest to the user and a geographic area in which the user desires to shop. Vendors of the designated product or service in the designated geographic area are selected, and a request related to the designated product or service is sent to the selected vendors. One or more advertisements related to the designated product or service are then sent to the electronic communication device in response to the data received from the device.

The geographic area desired by the user may be entered by the user manually, or may be assumed to be an area of some radius or grid around the user's position either as again entered by the user or as determined from a GPS-capable user communication device.

The vendors and advertisers will typically have preregistered, for example with a service provider that uses the methods described herein, with the vendors providing their location and a description of the products and services they provide; they may identify specific products, for example by model number. Advertisers provide advertisements, typically for products they sell or services they provide, again possibly identifying specific products. A database of the vendors and advertisements is stored; each vendor and advertisement is indexed and associated with one or more categories of products and services, in addition to having mapped associations to selected keywords, phrases and other unique and non-unique identifiers including models numbers, trademarks or service marks so that the vendors and advertisements most closely associated with a given user request may be quickly identified.

In various embodiments, the advertisements are sent to the user's communication device shortly after the request is received and processed, in one embodiment as quickly as possible. For example, where the request is processed by a computer or server the user should receive the advertisements in a matter of seconds, when they are most likely to have an impact on the user's shopping behavior.

In some embodiments, the selected vendors may include all vendors in the designated area who sell the product or service designated by the user, and may or may not include vendors who sell products or services in the designated category but have not indicated that they provide the specific designated product or service. In other embodiments, only a certain number of vendors will be selected; selection may be based upon subscription fees paid by the vendors, the ratings of vendors by prior users, the distance of the vendor to the user's location within the designated area, or any other desired factor.

In various embodiments, the advertisements may come from either a manufacturer of products or the local retailers of those products, and from either the manufacturer of a specific product designated by the user, a manufacturer of a related product, or a manufacturer of a competing product. Advertisements may also come from providers of services. Any desired number of advertisements may be sent, and available advertisements corresponding to the user's request may be ranked in order of priority according to any desired criteria. For example, in one embodiment advertisers may bid for the right to have their advertisement displayed first under various conditions.

Vendors may be entities such as stores or businesses, or sales representatives at such entities. Various embodiments allow for a wide range of communications between users and vendors, including for example, requests for quotations, offers, counter-offers, specification of any desired terms, discounts, etc.

Another application of the present invention allows for providing a user having interest in one or more categories of products or services with advertisements when the user is in the proximity of a vendor desiring to offer such advertisements in such categories.

### BRIEF DESCRIPTION OF THE DRAWINGS

FIG. 1 is an illustration of a network environment in which the present invention may be used.

FIG. 2 is a flowchart of a method according to one embodiment of the present invention.

FIG. 3 is a sample display indicating manufacturers that have provided advertisements that may be sent to a user device in response to a user request in one embodiment of the invention.

FIG. 4 is a sample display of an advertisement that might be sent to a user selecting one of the manufacturers indicated in FIG. 3 in one embodiment of the invention.

FIG. 5 is a sample display listing additional manufacturers that have provided advertisements that may be sent to a user device in response to a user request in one embodiment of the invention.

### DETAILED DESCRIPTION OF THE INVENTION

The present invention allows for a variety of communications between users interested in shopping for products or services, and the vendors, retailers and manufacturers of such products or services. Such communications occur electronically and are thus essentially real time, and also include “just-in-time” advertising during the user's search for products or services.

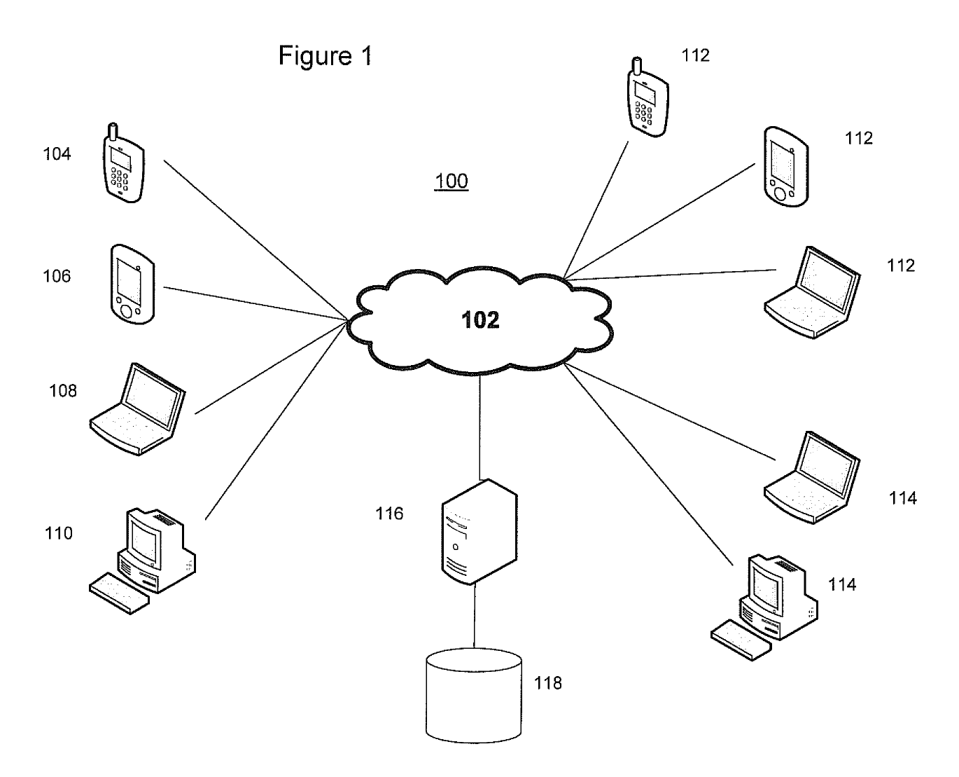

FIG. 1 shows a communication network environment 100 in which the present invention may be used. Users may access the Internet 102 through a variety of electronic communication devices, such as a “smart” cellular telephone 104, a PDA 106, a laptop computer 108, or a desktop computer 110. Any other user device capable of accessing the Internet may be used as well. Retailers 112 and manufacturers 114 may also access the Internet through similar devices.

A server 116 is similarly connected to the Internet 102, and contains or has access to a data storage device 118. The server 116 handles the communications between users 104-110, vendors or retailers 112 and manufacturers 114 as discussed herein.

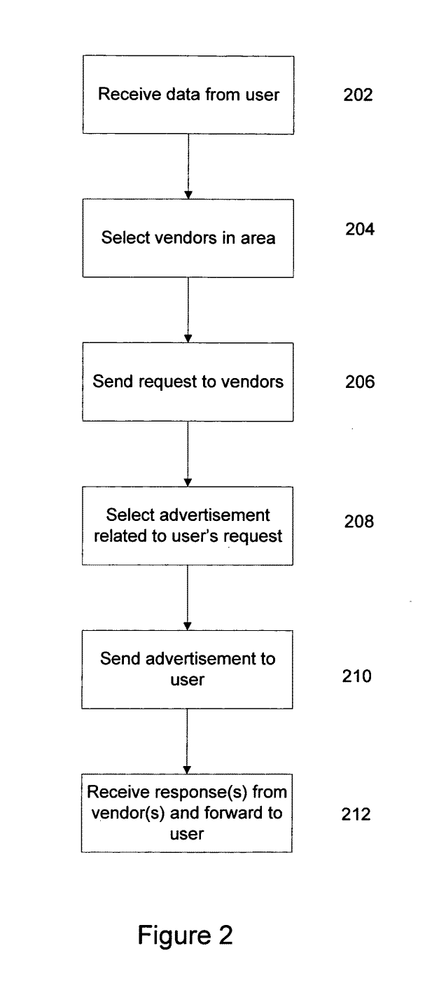

FIG. 2 is a flowchart of a method performed by the server 116 of FIG. 1 according to one embodiment of the invention. At step 202, data is received from a user via an electronic communication device such as those shown in FIG. 1. The data designates a product or service of interest to the user, and a desired geographic area. At step 204, one or more vendors are selected as possibly being able to provide the designated product or service, and as being located in the desired geographic area.

At step 206, the user's request is forwarded to the selected vendors via their communication devices, such as devices 112 in FIG. 1. At step 208, one or more advertisements which are related to the designated product or service are selected from a database of available advertisements, and at step 210 are sent to the user's electronic communication device in response to the data received from the user. At step 212, one or more responses are received from the vendor(s) to which the request was sent, and forwarded to the user's device. As will be evident, in some cases the order of steps is important while in other cases the order may be changed; for example, the advertisement may be selected and sent before vendors are contacted. These steps will now be described in more detail.

Prior to the execution of the method illustrated in FIG. 2, one or more databases are created with certain information. This database may, for example, be stored on a device such as data storage device 118 in FIG. 1. In one embodiment, categories of available goods and services are established. A set of products or services and their related brands are stored in the database, and each brand or product or service is associated with one or more of the categories of goods or services.

A set of vendors and retailers is also stored in the database. Vendors and retailers who have chosen to participate submit information about the categories in which they offer products or services, and may indicate the specific brands or products that they offer and any other desired information. Thus, each vendor or retailer is also associated with one or more of the categories of goods and services. Each vendor or retailer provides its location, which is typically a street address, but may also be latitude and longitude coordinates, geohash coordinates, or similar coordinate encoding systems, from which its geographical coordinates are determined for inclusion in the database.

The set of vendors and retailers may include not only stores or businesses, but also individual persons such as sales representatives. For example, sales representatives at larger chain stores may choose to be listed, again with the goods or services that they provide in combination with their location data, so that they may participate in the sales process described herein. Thus, a sales representative at a large chain store may choose to be listed as a way of locating customers other than those who walk in the door. Vendors, retailers and sales representatives are hereinafter referred to collectively as vendors.

Entities that have chosen to participate provide advertisements for some or all of their products. These advertisements are also stored in the database; while it is expected that the advertisements will primarily be submitted by manufacturers and will specifically identify the manufacturers' brands and/or products, it is possible that an advertisement may be submitted by a local vendor or retailer or may relate to an entire category, but in either event each advertisement is thus at least similarly associated with one or more of the categories of goods and services. The advertisements are correlated to the categories based upon their content, including any special keywords and/or phrases, model numbers, trademarks, servicemarks, slogans, brand names, or other identifiable keying characteristics.

Data is sent by a user via an electronic communication device, such as devices 104-110 in FIG. 1. The data designates a desired product or service and is received from the user at step 202. The user's designation of a desired product or service may be performed in a variety of ways. In some embodiments, the user may be shown on the display of the communication device a list of the categories of available products and services stored in the database, and, after selecting a category, may then view the products, brands and/or services associated with that category. The user may then select one of the products or services. The selection of the category and product or service may be performed by means of a hyperlink, by selecting a number corresponding to the desired product or service, by sending a text message, or any other means of selection.

In other embodiments, the user may enter an alphanumeric string, such as one enters in a typical request to a search engine, containing words or phrases that identify the specific product or service of interest to the user. The alphanumeric string is parsed, for example by server 116, to extract the identifying words or phrases, and the database searched for the product, brand or service in the database which most closely appears to correspond to the string entered by the user. There are a number of commercially available hardware and software based content “indexers” that provide methods to search for keywords or portions of words within searchable text content. If the request is unclear, an error message may be returned, or, if more than one product, brand or service appears to fit the data entered by the user, a list of potential matches may be returned to the user and the user asked to select one of the items on the list or to start over if none of the items on the list are what the user intended.

In addition to identifying a product or service, it is expected that the data received from a user will include the designation of a geographic area in which the user is interested in shopping. This geographic data may be obtained in a variety of ways. In one embodiment, the designated location may be automatically generated by the communication device as the user sends data, i.e., in a device having GPS capability the location of the device may be automatically submitted along with the data entered by the user. This allows the user's exact present location to be determined.

In other embodiments, the user may manually enter location data by entering a location, ranging from a specific street address to the name of a particular city or town, or a zip code or telephone area code. Such an embodiment may be chosen in cases where the user's device does not have the ability to provide its own location (for example, is not GPS enabled), because the user is interested in shopping in a location other than that in which the user is presently located, for example if the user is planning a trip to another city or town, or for any other appropriate reason.

In some embodiments a radius or grid from that location is also specified, thus determining the area within which the user will be presented with choices of vendors. In some embodiments, a user may be able to specify a distance which he or she is willing to travel to shop, for example 5 miles, 10 miles, 25 miles, etc. In other embodiments, a default radius or grid (or perhaps more than one, as discussed below) is preset in the system and is not alterable by the user. In still other embodiments, a radius or grid is preset but the user is given the ability to override the default to set the user's own choice. Since the specified radius or grid may have a significant impact on the number of vendors presented to the user and contacted by the system, it may be desirable to allow the radius or grid to be modified by either the user or the system as the number of vendors is being determined; this is discussed in more detail below.

The data submitted by the user may also include additional information. For example, a user may make a request for quotation (RFQ) asking for the price and/or terms on which a vendor will provide a particular product or service. Alternatively, the user may propose the price or terms upon which the user wishes to purchase the designated product or service and ask whether any vendors will agree to the specified price or terms. In some embodiments, the data is sent in a predetermined format; for example, the user may fill in a form RFQ or may be asked to fill in fields with the desired price, location, or other terms. In other embodiments, as with the selection of a product or service as above, the user may enter a text string, for example asking what the best price on the desired product or service is or whether it can be purchased for a specific price.

If the user data is received in a predetermined format, it is expected that the server will be able to clearly ascertain the meaning of the request by simply reading the data entered in the fields. However, in some embodiments, for example if a field is empty or contains inappropriate data, or if the request is in the form of an alphanumeric string, the server may need to parse the data and attempt to determine the meaning of the request. If the meaning is unclear, the server may send a message back to the device from which the data was received either asking for clarification, for example asking the user to complete all fields or which of multiple products the user is interested in, or simply stating that the server cannot determine the meaning and asking the user to try again.

Upon receiving this information from the user's communication device, at step 204 the server searches the database of vendors which have registered and selects those who most closely match the user's request and which are located within the designated geographic area. In some embodiments, the system first looks for vendors who match the user's request and then selects from those vendors the ones within the designated area. In other embodiments, all vendors in an area might be selected first and then those vendors offering the requested product or service selected.

Which vendors are considered to match the user's request may be determined in a variety of ways. In some embodiments, the vendors deemed to match the request will be all of the vendors who have indicated that they provide the actual product or service requested by the user, as well as all vendors who have indicated that they provide any products or services in the category corresponding to the user's request. In other embodiments, a vendor who is within the category but specifies only other products or services in the category will be omitted, while those vendors specifying the category but no specific products or services will be included. In still other embodiments, a vendor within a category that specifies no products will only be included if there are no vendors who specify the request product or service.

As above, in various embodiments, the desired geographic area may be designated solely by the user, or may be determined by the system based upon the automatically reported location of the user device and either a preset or user selected radius or grid. If the exact location of the user is known, either through data from a GPS enabled device, the user's entering a specific street address, by selecting a desired location via a virtual map upon the device, or any other method, and if the addresses of the vendors are known, then it is straightforward to choose only those vendors within the specified radius or grid.

In other cases, as above, the exact location of the user may not be known, either because the user's communication device is not GPS enabled, or the user has chosen to enter a less precise location for some reason, such as discussed above. In some embodiments where this is the case, vendors may be selected within the geographic area designated by the user either by selecting those vendors who are located in the same city or town, zip code, or area code as the user, or those vendors who are located within a predetermined radius or grid of the center or other designated point within the area specified by the user.

In some embodiments, all of the vendors that are deemed to match the user's request and that are located in the designated geographic area will be selected. In other embodiments, a specified number of vendors may be selected. For example, it may be determined that no more than 50 vendors should be selected; such a limitation may be imposed by the system or may be specified by the user.

In a case where the number of available vendors exceeds such a limit, priority may be given to those that have indicated that they can provide the specific product or service, with those indicating categories without specific products or services only added until the desired number of vendors is reached. Alternatively, priority of inclusion may be given based upon subscription fees paid by the vendors. In a simplest form, those vendors willing to pay higher subscription fees may be given priority over those paying less, while in another embodiment, a vendor's subscription fee will result in a radius or grid within which a user must be located to have the vendor appear to the user, so that higher fees result in a greater radius or gird and thus more contacts. Priority of inclusion in the list of selected vendors may also be based upon other criteria, such as relative ratings of vendors by prior shoppers or the number of requests to which the vendor has previously responded.

Priority of display may be based on any other desired factors as well. For example, priority may be given to vendors having special characteristics, designations, expertise, specializations, authorizations, credentials, licenses, or other or any other desired factors. Such factors may be considered by the server, or filtered on the device itself using filtering technologies such as bitmasking as discussed below to limit the display of vendors to those fitting the desired factors.

In some embodiments, if desired the selected vendors may be displayed on the user's communication device, either in a text listing or graphically, such as on a map showing the location of each vendor, prior to the user's request being sent, and the user given the option of removing vendors from the list to which the request will be sent. Such graphical display may be one reason for limiting the number of vendors included, so that the map does not become unreadable due to the large number of available vendors.

Any other information may optionally be displayed, such as the ratings of vendors by prior shoppers, thus permitting the user to select only those vendors that the user wishes to receive the request. In a textual display, the order of display may be determined by factors such as those discussed above, such as the amount of subscription fees paid by each vendor, prior shoppers' ratings, etc., or the vendors may be displayed in alphabetical order or in order of their proximity to the user's location.

At step 206, the server sends information to the selected vendors. In some embodiments, the user's information may simply be forwarded to the vendors by, for example, email or text message. Thus, if the user has filled in a predefined form, the form may be forwarded as it was entered by the user. An alphanumeric string input by a user may similarly be forwarded to vendors in the same way. In other embodiments, the information may be forwarded in a different form. If the server has parsed the user's request to determine what product or service the user has designated, or asked the user for further clarification, the result may be forwarded to vendors rather than the original request itself.

Other information may be included in the transmission to the vendors if desired. For example, in some embodiments the server may track how many requests or offers a user has submitted, and how many of those requests or offers resulted in purchases, and include this information with a new request from the same user that is forwarded to vendors. This information may assist vendors in determining whether and how to respond to a new request by expending less effort on user who do not appear to be serious based upon prior behavior, or on the other hand considering whether to add extra incentives to entice users who have a track record of completing transactions. In addition, accepted offers may be made public, and the transaction terms, store name, and location may be sent to losing vendors so they may determine how best to compete in the future.

As above, the database also contains a number of advertisements submitted by vendors, retailers, or manufacturers, which may be for specific products or services or for categories. Where an advertisement designates specific products, services, brand names, or other identifying characteristics such as model numbers, it will be associated with one or more categories based upon the content of the advertisement, i.e., those products, services, brand names or other characteristics. Thus, any category in the database will have associated with it a number of advertisements, some of which relate only to the category as a whole, while others relate to specific products, services or brand names.

At step 208, the server selects one or more advertisements from the category with which the product or service designated by the user is associated, and sends the selected advertisement(s) to the user's device for display to the user. An advertisement may be selected for the same product or service designated by the user's request, for the category containing the product or service designated by the user's request, for a related or competitive product or service in the same category, or possibly even for a related category. By the use of these advertisements, manufacturers may have the opportunity to influence a user's decision, either by the content of the advertisement, or by the providing of some additional incentive, such as a discount or coupon, directly from the manufacturer of either the same product or service requested by the user or a competitive product or service. In order to maximize the effectiveness of the advertisements, users may be required to view at least one advertisement before they can complete a transaction.

Selecting which advertisement to send to the user's device may utilize any number of desired factors, and these may be combined in any desired way. In one embodiment, each manufacturer may bid for the right to have its advertisement presented first under certain conditions, with the highest bid matching the conditions of the user's request resulting in the first advertisement sent to the user, and the next highest bids resulting in the following advertisements, etc. The conditions of each bid may be varied; for example, a manufacturer may bid one amount to have its advertisement sent to those users who designate its product, and a different amount to have the same advertisement sent to users designating a competitive product. Other methods of selecting which advertisements to send to the user may also be utilized.

The vendors who have received RFQs or bids from users have the opportunity to respond to those requests. In the case of an RFQ the vendor's response to the user will typically be an offer to sell the requested product or service at a certain price, and may contain other terms as well. Where the user has entered a specific offer, the response by a vendor may be a direct acceptance of the user's offer, a counter-offer proposing a different price or other terms, or a request for further information if the vendor believes such information is necessary to properly respond.

If desired, all of the communications between users and vendors may be maintained and analyzed. This may provide valuable information. As above, it allows users to see the ratings of vendors and determine whether they prefer to deal with certain vendors over others; similarly, vendors may see users' records to determine whether a given user is a committed shopper or “looker.” Perhaps more importantly, having access to this information allows vendors to track their success rates and determine whether they are making an acceptable return on their investment in the process. This information may also be available for real time or future analysis to formulate user trends and metrics, establish forecasts, determine word associations, plan marketing activities, and determine shopper interests, pricing levels, and other adaptive requirements in specific locations or areas.

If this information is stored, it is desirable that both the user and the vendor should have an incentive to report the purchase, as incomplete data may not be meaningful. As above, in some embodiments, both the user and the vendor will get better ratings in the system, which may result in the user receiving better offers, while the vendor may get higher visibility in the selection process as above and may receive more interest from users who wish to deal with the highest rated vendors.

The present invention uses geo-spatial searching on latitude and longitude coordinates to allow for easy translation of locations and to establish associated regional meanings to coordinate data in order to map advertisements based in part on the location data. There are several known methods of representing such geographical coordinate data. In one embodiment the Geohash format is the method of using the geo-location coordinate data as the basis for identifying, searching for, and establishing regional and neighboring relative locations, i.e., providing a known location and identifying other locations within an established region (grid or radius) surrounding the location provided. Using Geohash, the user provides an address to be geographically encoded (or “geocoded”) from the latitude and longitude coordinates. Vendor locations may similarly be geocoded. The methods of encoding and decoding a Geohash are well known to one of skill in the art

There are other methods of performing geo-location representation from standard latitude and longitude coordinates that are known to one of skill in the art and may be utilized to perform a geographic location search within a predefined area. For example, published United States patent application number 20050023524 entitled “Compact text encoding of latitude/longitude coordinates,” teaches an algorithm to convert the coordinates of longitude and latitude into non-negative integers using a character set map.

Another example is the Natural Area Coding System developed in the late 1990's by NAC Geographic Products Inc. A patent application was filed in the United States, as well as a subsequent international patent application, but these were apparently later abandoned and the methods made public as a proprietary standard protected by the International Copyright Laws.

Still another method of searching geo-location latitude and longitude data in an SQL environment is to do range inquiries on raw latitude and longitude coordinate ranges. This can be done using any of three known clauses that can be utilized to compare data and retrieve known records that match the conditional statements. Two known examples of such clauses include the “between” clause and using “less than” and “greater than” comparators.

As is also known to one of skill in the art, GeoHashes or other geo-location representations and or taxonomy data can be indexed and searched for GeoHashes, geo-location latitude and longitude coordinates data, keywords, and on other kinds of textual data. Some examples of known solutions that utilize hardware and software based indexers are Google Mini and Google Appliance, a Google-developed crawler and indexing hardware appliance and enterprise class crawler and indexing hardware appliance, respectively, and Lucene, a software based full-text indexer of which there are several Unix/Linux variants available.

However, it is important that such indexing and searching take place quickly so as not to impede the user's ability to shop quickly. The client-side and server-side processes of the present invention utilize search techniques that allow very fast correlations, searches and lookups to be performed using either a concatenation and/or combination of geohash location identifiers mapped to taxonomy trigger keywords, and phrases. This tightly correlates individual vendors and/or selected advertisements with the mapped products and services taxonomies utilizing indexed, inverse-indexed, and relational database data.

Specific search techniques that may be used in the present invention include the use of database dependent substring search functions which return the nth left-most characters of a substring, cumulatively known as “LEFT” functions which are scripted in combination with standard SQL query search commands. The LEFT function serves to limit the precision of a representative Geohash value, thus increasing the representative grid region area. The combined use of the “LEFT” function with SQL commands referencing a selected Geohash field, allow for rapid search of well defined geocoordinate-related taxonomy records. A simple example of an SQL query where the left 5 characters of the GeoHash field is compared within a defined set of neighboring grid Geohashes predicated upon the “LEFT” function could be shown as:
SELECT LEFT(v.geohash_field_name, 5) IN (‘9q9kd’, ‘9q9k4’, ‘9q9k7’, ‘9q9k3’, ‘9q9k9’, ‘9q9ke’, ‘9q9k5’, ‘9q9k1’, ‘9q9k6’), v.vendorID FROM vendors v, categories c, rel_vendors_categories vc WHERE c.categoryID=100 AND c.categoryID=vc.categoryID AND v.vendorID=vc.vendorID

The client-side and server-side processes of the present invention also utilize techniques that aid in increasing data throughput and compressing the data into a functional format that allows for implicit meaning of the data in its compressed format. There are a variety of techniques of accomplishing the compression, decompression and translation of the data while retaining meaning within the compressed format that will be well known to one of skill in the art.

One of these techniques is bitmask filtering of data in real-time. In the present invention, bitmasking allows the attributes of vendors, products and services to be represented in an integer numerical fashion by associating a specific bit with a particular attribute that a vendor, product, or service has. For example, when returning the results for hair stylist in a list of many similar service providers, an associated bitmask could be constructed where the first bit represents whether the stylist performs “color dying” services, the second bit represents “permanents,” the third bit represents “hair extensions”, etc. Thus, using a bitmask integer it is possible to convey many services that the stylist is licensed to perform without having to list each such service explicitly for the stylist. Given a key and the stylist's bitmask, a consumer can quickly select only those stylists whose bitmask contain the specific representation of the services of interest to the consumer. This technique allows bitmasks to be utilized as a very quick and efficient method of filtering data and locating those providers that exactly meet the criteria being sought.

In another example of assigning or “mapping” the meaning the each bit to a specific value, multiple bits may be used to indicate multiple possibilities of a single value. For example, a bitmask to describe the attributes of a sweater could be represented by the first three bits indicating the color, the next three bits representing the size and a final two bits representing the material the sweater is made of. Thus, a bit mask might have the following values for bits:

bit 1=red

bit 2=green

bit 3=blue

bit 4=small

bit 5=medium

bit 6=large

bit 7=cotton

bit 8=wool

Thus, using bit-shifting (described below) a blue medium cotton sweater could be represented by the number 84, which is the decimal representation of the binary bitmask 01010100.

The use of bitmasking further allows searching for matches using bit-shifting techniques. Bit-shifting involves either multiplying or dividing an integer by powers of two to determine the bitmask for which the integer is a representation. Thus, the number 5 is a representation of a bitmask 0101 (there may be more leading 0's), and as above 84 represents a bitmask 01010100. There are a number of techniques for searching for matches using SQL that will be known to one of skill in the art. For example, enterprise class SQL engines (including Microsoft SQL Server and Oracle) can utilize bitmasks in their binary form to conduct searches for attribute states, and thus locate products and services stored in bitmask form.

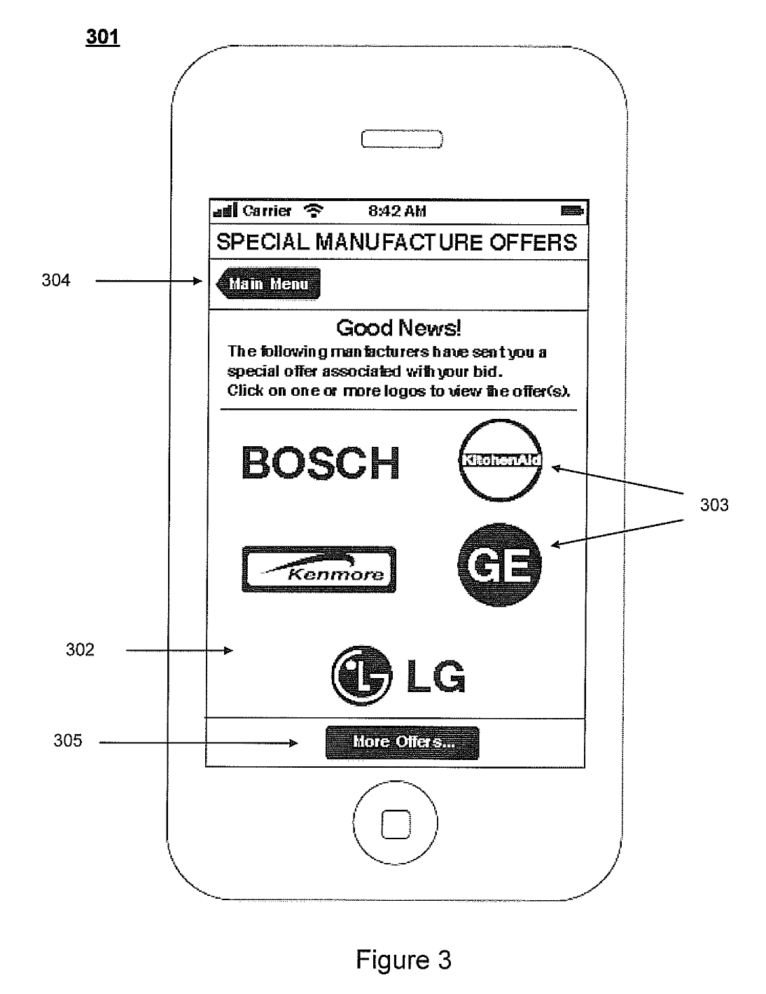

Some examples of the advertisements that may be utilized in the present invention will now be discussed. Assume that a user enters a make and model of a washing machine that the user is interested in purchasing. The request is received by the server and the database searched for relevant advertisements. In one embodiment, the server determines that the request is for a washing machine and presents the user with the display shown in FIG. 3.

FIG. 3 shows a user device 301 on which is displayed an advertisement 302, containing the logos 303 of five manufacturers, with a text portion 304 of the display containing a message indicating that each of the manufacturers has an offer to make to the user. As above, the manufacturers might be selected on the basis of having made the highest bids to present their advertisements to users who are interested in washing machines. Other factors may be considered as well if desired, with any weighting that is deemed appropriate; for example, some priority may be given to those manufacturers whose offers have received the most acceptances from prior users, have the best ratings from prior users, etc.

If the user selects one of the five manufacturers shown on the display of FIG. 3, for example by clicking on one of the logos 303 on that display, another advertisement is sent to the user's device which is specific to the chosen manufacturer. This advertisement may contain further information about the manufacturer or a product, such as an offer that the manufacturer is willing to make to users interested in washing machines.

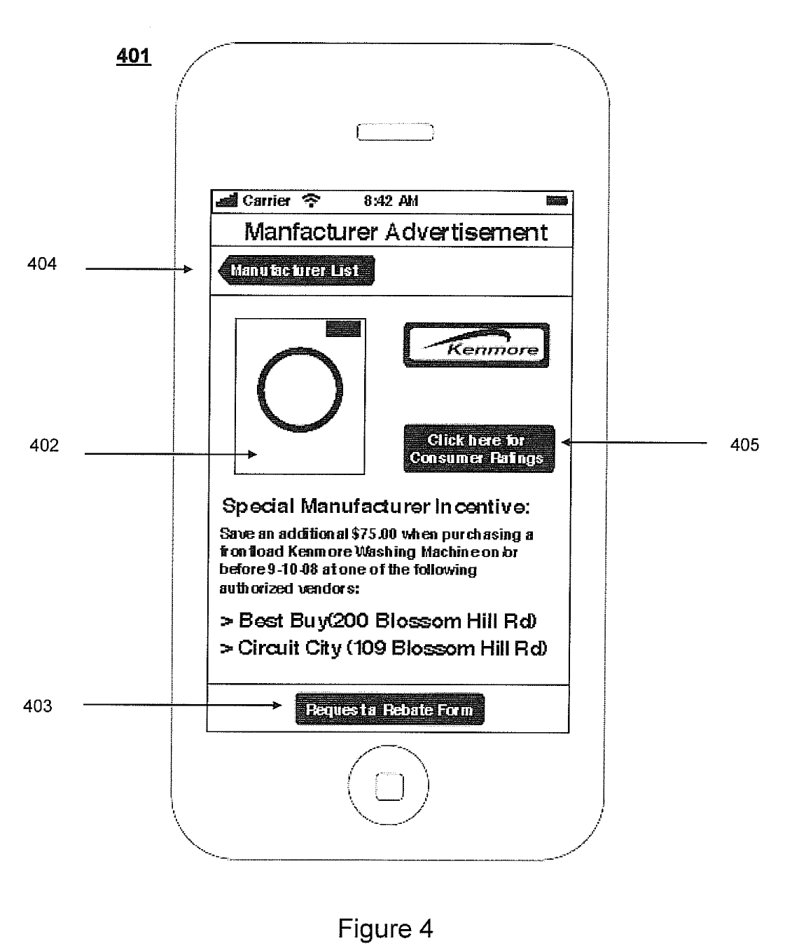

For example, if the user selects the “Kenmore” logo from the display of FIG. 3, one possible outcome is that the user will be presented with the additional advertisement shown in FIG. 4. FIG. 4 again shows a user device 401 on which is displayed an advertisement 402. In this example, advertisement 402 presents the user with an offer from the manufacturer, here to receive an additional discount if the user purchases a Kenmore washing machine before a certain date from one of the vendors listed in the advertisement. The advertisement indicates that the discount is in the form of a mail-in rebate, and provides a link 403 from which the user can download the rebate form.

Other options may be presented as well. For example, as shown in FIG. 4 a link 404 is provided by which the user may return to the manufacturer list, for example if the user wishes to see what other offers are available. Another link 405 allows the user to see consumer ratings of the Kenmore washing machine; this link may retrieve data stored on the server or may take the user to an independent site that provides such ratings.

A display generated in response to the user's request such as that shown in FIG. 3 may contain any number of desired logos or text entries, as desired, as long as there is sufficient room on the display so as to be legible to the user. If there are more than manufacturers interested in presenting advertisements than will fit on the display, an option to see more manufacturers may also be presented. As shown in FIG. 3, this is done via a button 305 labeled “More Offers . . . ” that the user may select to reach the additional manufacturers.

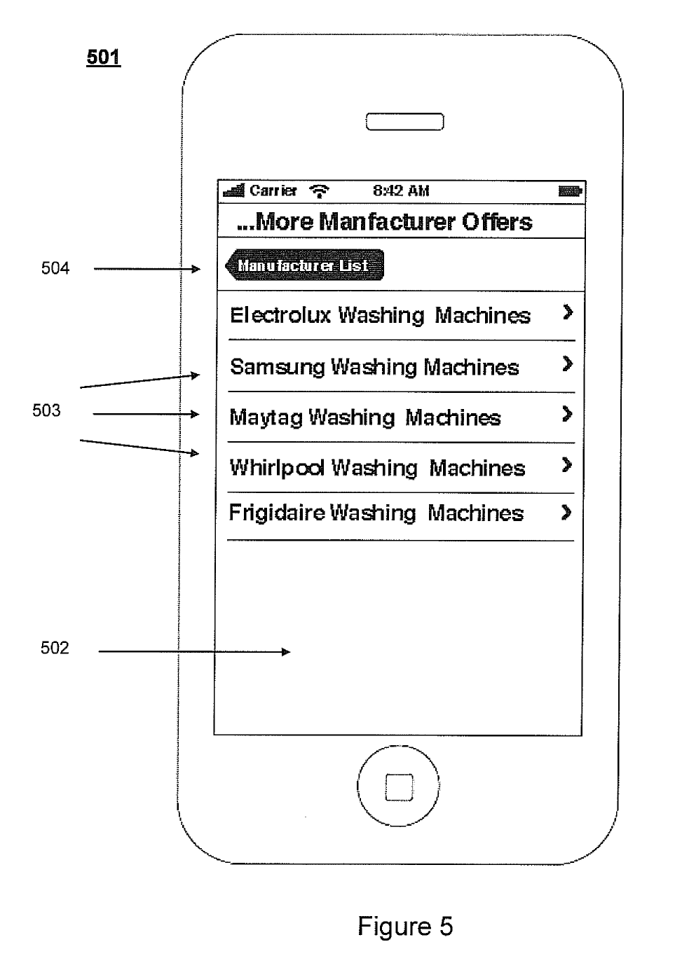

If the user chooses this option, the user is presented with a more basic display such as that shown on user device 501 in FIG. 5. The display 502 in FIG. 5 is a list of additional manufacturers 503, rather than logos. The user may be able to select one of these manufacturers 503, again by clicking on them, to view advertisements specific to that manufacturer. As shown in FIG. 5, there is also a button 504 which the user may select to return to the prior screen shown in FIG. 3.

One reason that the more basic display of FIG. 5 may be preferable when the user selects “More Offers” is that it allows more manufacturers to be viewed on a single display since the logos may typically occupy more space than text listings. Also, in various embodiments, manufacturers may pay more to be presented on the first display as shown in FIG. 3 with logos than on the secondary display of FIG. 5, as it is expected that being on the first display rather than the second and having a logo rather than a mere text listing will have more impact on the user.

Many other features may be added using the above-described capabilities of the present invention. One such feature that uses the GPS capability of some user communication devices is proximity alerts allowing for the localized presentation of advertisements. This feature allows users to register their interest in desired categories by registering with the system. The system may then determine the location of registered users either on a continuous basis, timed interval, or upon an on-demand request from a user to deliver advertisements in either a server “push” or a server “pull” manner. Similarly, vendors may register their desire to present offers to users in their area. When the system determines the location of a specific user, it then checks to see if any vendors in that area have registered offers that they wish presented, and, if so, whether the offers are in any of the categories in which the user has expressed interest. If all of these conditions are met, the user will then receive offers from vendors in their vicinity in the designated categories. In this manner, vendors may send offers to users who have agreed to receive them, rather than having to wait for a user to submit a request as described above.

The invention has been explained above with reference to several embodiments. Other embodiments will be apparent to those skilled in the art in light of this disclosure. The present invention may readily be implemented using different orders of steps, configurations other than those described in the embodiments above, or in conjunction with systems other than the embodiments described above. It should also be appreciated that the present invention can be implemented in numerous ways, including as a process, an apparatus, a system, a computer readable storage medium such as a hard disk drive, floppy disk, optical disc such as a compact disc (CD) or digital versatile disc (DVD), flash memory, etc., on which program instructions for performing the methods described herein are stored, or a computer network wherein the program instructions are sent over optical or electronic communication links. It should be noted that the order of the steps of the methods described herein may be altered within the scope of the invention. These and other variations upon the embodiments are intended to be covered by the present invention, which is limited only by the appended claims.

What is claimed is:

1. A method for providing advertising to a user of an electronic communication device, comprising:
receiving data from the electronic communication device designating a product or service and a geographic area;
selecting vendors of the designated product or service in the designated geographic area;
sending a request related to the designated product or service to the selected vendors; and
sending an advertisement related to the designated product or service to the electronic communication device in response to the data received from the device.

2. The method of claim 1 wherein sending an advertisement to the electronic communication device is substantially contemporaneous with receiving the data from the electronic communication device.

3. The method of claim 1 further comprising receiving a response from a vendor and forwarding the response to the electronic communication device.

4. The method of claim 3 wherein the response from the vendor includes an offer to provide the designated product or service for a specified price.

5. The method of claim 1 wherein receiving data from the electronic communication device further comprises receiving data indicating a desire to purchase the designated product or service on specified terms.

6. The method of claim 5 further comprising receiving a response from a vendor and forwarding the response to the electronic communication device.

7. The method of claim 6 wherein the response from the vendor includes an agreement to the terms specified in the offer to purchase.

8. The method of claim 6 wherein the response from the vendor includes a counter-offer to provide the designated product or service on different terms.

9. The method of claim 1 further comprising:
storing a plurality of categories of available products or services, each category being associated with one or more vendors; and
selecting one of the categories based upon the data received from the electronic communication device;
and wherein selecting vendors further comprises selecting vendors that are associated with the selected category.

10. The method of claim 9 wherein sending an advertisement further comprises sending an advertisement for a product or service associated with the selected category.

11. The method of claim 10 wherein the advertisement is for the designated product or service.

12. The method of claim 10 wherein the data from the electronic communication device indicates a manufacturer of the designated product and the advertisement is from the indicated manufacturer.

13. The method of claim 10 wherein the data from the electronic communication device indicates a manufacturer of the designated product and the advertisement is for a product or service from a competitive manufacturer.

14. The method of claim 10 further comprising selecting the advertisement from a set of pre-stored advertisements, each of which is associated with the selected category.

15. The method of claim 14, wherein each advertisement is also associated with a priority rating, and selecting the advertisement further comprises selecting the advertisement having the highest priority rating from the advertisements associated with the selected category.

16. The method of claim 10 further comprising:
selecting a plurality of advertisements from a set of pre-stored advertisements, each of which is associated with a category and with a priority rating; and
sending the plurality of advertisements to the electronic communication device, in an order determined by the priority ratings of the advertisements.

17. The method of claim 14 further comprising receiving demographic data of the user of the electronic communication device.

18. The method of claim 17 wherein each advertisement is also associated with demographic data, and selecting the advertisement further comprises receiving selecting an advertisement demographic data of which most closely matches the demographic data of the user.

19. The method of claim 9 further comprising pre-storing a set of vendors, each of which is associated with one or more of the plurality of categories of available products or services and a geographic area, and selecting vendors further comprises selecting those vendors which are associated with the selected category and the designated geographic area.

20. The method of claim 19 wherein receiving data from the electronic communication device designating a geographic area further comprises receiving data entered by the user indicating a desired area.

21. The method of claim 19 wherein receiving data from the electronic communication device designating a geographic area further comprises receiving data automatically generated by the electronic communication device indicating its location.

22. The method of claim 21 wherein each of the pre-stored vendors is further associated with an address, and selecting vendors associated with the designated geographic area further comprises selecting vendors whose address is within a predetermined distance of the location of the electronic communication device.

23. A system for providing advertising to a user of an electronic communication device, comprising:
a data storage device for storing a database of vendors and advertisements;
data receiving means for receiving data from the electronic communication device designating a product or service and a geographic area;
a processor for analyzing the received data and selecting vendors of the designated product or service in the designated geographic area; and
transmission means for sending:
a request related to the designated product or service to the selected vendors; and
an advertisement related to the designated product or service to the electronic communication device in response to the data received from the device.

24. A computer-readable storage medium having embodied thereon a program, the program being executable by a processor to perform a method for providing advertising to a user of an electronic communication device, the method comprising:
receiving data from the electronic communication device designating a product or service and a geographic area;
selecting vendors of the designated product or service in the designated geographic area;
sending a request related to the designated product or service to the selected vendors; and
sending an advertisement related to the designated product or service to the electronic communication device in response to the data received from the device.
